(19) United States
(12) Patent Application Publication
(10) Pub. No.: US 2026/0203010 A1
(43) Pub. Date: Jul. 16, 2026

(54) VOLUME ADJUSTMENT

(71) Applicant: Beijing Zitiao Network Technology Co., Ltd., Beijing (CN)

(72) Inventors: Chang XIAO, Beijing (CN); Manjia CHEN, Beijing (CN); Jiamin ZHANG, Beijing (CN); Weisi WANG, Beijing (CN)

(21) Appl. No.: 19/449,105

(22) Filed: Jan. 14, 2026

(30) Foreign Application Priority Data
Jan. 15, 2025 (CN) 202510067779.7

(51) Int. Cl. G06F 3/16

(52) U.S. Cl. CPC G06F 3/167

(57) ABSTRACT

A method for volume adjustment, a device and a storage medium are provided. In the method, respective noise levels of a plurality of audio segments of audio are obtained from a first queue, to obtain a plurality of first noise levels, wherein the audio is captured in association with a device, and second noise levels determined based on the plurality of first noise levels are stored into a second queue. In response to the second noise levels stored in the second queue satisfying a predetermined condition, a third noise level of the audio is determined based on the second noise levels stored in the second queue, and based at least on the third noise level of the audio, a playback volume of the device is adjusted to a volume level matching the third noise level.

### CROSS-REFERENCE

This application claims the benefit of Chinese Patent Application No. 202510067779.7 filed on Jan. 15, 2025, entitled “METHOD, APPARATUS, DEVICE, AND STORAGE MEDIUM FOR VOLUME ADJUSTMENT”, which is hereby incorporated by reference in its entirety.

### FIELD

Example embodiments of the present disclosure generally relate to the technical field of computers, and more particularly, to volume adjustment.

### BACKGROUND

With the development of society, noise problems in living and working environments are increasingly prominent. In order to address this challenge, devices with adaptive volume regulation function for ambient noise are currently available. These devices are capable of capturing and analyzing sound signals of the surrounding environment in real time with high accuracy. By applying the noise recognition algorithm and the like, the devices may distinguish the noise signal, and automatically adjust their volume output based on quantization analysis of the noise signal, such that users may clearly hear the sound played by the device under different noisy environments.

### SUMMARY

In a first aspect of the present disclosure, a method for volume adjustment is provided. The method includes: obtaining, from a first queue, respective noise levels of a plurality of audio segments of audio, to obtain a plurality of first noise levels, wherein the audio is captured in association with a device; storing second noise levels determined based on the plurality of first noise levels into a second queue; determining, in response to the second noise levels stored in the second queue satisfying a predetermined condition, a third noise level of the audio based on the second noise levels stored in the second queue; and adjusting, based at least on the third noise level of the audio, a playback volume of the device to a volume level matching the third noise level.

In a second aspect of the present disclosure, an apparatus for volume adjustment is provided. The apparatus includes: a noise level obtaining module configured to obtain, from a first queue, respective noise levels of a plurality of audio segments of audio to obtain a plurality of first noise levels, wherein the audio is captured in association with a device; a noise level storage module configured to store second noise levels determined based on the plurality of first noise levels into a second queue; a noise level determining module configured to determine, in response to the second noise levels stored in the second queue satisfying a predetermined condition, a third noise level of the audio based on the second noise levels stored in the second queue; and a volume adjusting module configured to adjust, based at least on the third noise level of the audio, a playback volume of the device to a volume level matching the third noise level.

In a third aspect of the present disclosure, an electronic device is provided. The device includes at least one processor; and at least one memory coupled to the at least one processor and storing instructions executable by the at least one processor. The instructions, when executed by the at least one processor, cause the device to perform the method of the first aspect.

In a fourth aspect of the present disclosure, a computer-readable storage medium is provided. The computer readable storage medium stores computer-executable instructions executable by the processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a flowchart of an example process for volume adjustment according to some embodiments of the present disclosure;

FIG. 3 illustrates a schematic diagram of an example of a first queue and a second queue according to some embodiments of the present disclosure;

FIG. 4 illustrates a schematic diagram of an example of determining an adjustment gain according to some embodiments of the present disclosure;

FIG. 5 illustrates a schematic block diagram of an apparatus for volume adjustment according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the embodiments of the present disclosure, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As briefly described above, the current device may have the function of automatically adjusting the playback volume according to the ambient noise. This function is intended to provide users with a more comfortable, immersive auditory experience. The device captures the noise level in the surrounding environment through a built-in sensor or a microphone, and dynamically adjusts the playback volume according to the noise level, such that the user may clearly hear the audio content in different noisy environments.

However, in the actual application process, the accuracy of the device in the noise estimation is a non-negligible problem. The accuracy of the noise estimation is directly related to the accuracy of volume adjustment. When the device is in a complex and variable noisy environment, e.g., a public place such as a street, a station and the like, due to diverse and frequent changes of noise sources, it may be difficult for the device to accurately distinguish and identify various noises, resulting in jitter in the noise estimation result.

In addition, the jitter is particularly noticeable in solutions where noise estimation is made based on a small number of audio frames (e.g., a single audio frame). The single audio frame, as a basic unit in audio processing, usually has a short duration and includes limited noise information. In the case that the device estimates the noise level only based on the single audio frame, due to the insufficient data amount and the randomness of the noise, it is easy to cause a large jitter in the result of the noise estimation. In this case, the device may erroneously determine the noise level, leading to inappropriate increases or decreases in playback volume. This sudden volume change may break the user's original auditory balance, and cause discomfort to the user, affecting the auditory experience of the user.

In view of this, embodiments of the present disclosure provide a solution for volume adjustment. According to the solution, respective noise levels of a plurality of audio segments of audio are obtained first from a first queue, to obtain a plurality of first noise levels, where the audio is audio captured in association with a device. Second noise levels determined based on the plurality of first noise levels are then stored into a second queue. Then, in response to the second noise levels stored in the second queue satisfying a predetermined condition, a third noise level of the audio is determined based on the second noise levels stored in the second queue. Based at least on the third noise level of the audio, a playback volume of the device is adjusted to a volume level matching the third noise level.

As will be more clearly understood from the following description, the solution of the present disclosure achieves dual “buffering” of the noise level in the first queue by using the first queue and the second queue. Such buffering mechanism may smooth the jitter in the noise level in the first queue, thereby improving the stability of noise estimation.

Specifically, the initial noise level in the first queue may exhibit jitter due to various factors. To smooth the jitter, the solution of the present disclosure introduces first-stage “buffering”. For example, the solution of the present disclosure integrates a plurality of noise levels in the first queue through certain statistical methods (such as averaging, median calculation, etc.), to obtain the second noise level. Then, the second noise level is stored into the second queue. In this way, the noise levels stored in the second queue may be preliminarily smoothed and relatively stable.

On this basis, the solution of the present disclosure does not directly perform volume adjustment based on every individual noise level in the second queue. Instead, it sets a predetermined condition. When the second noise level stored in the second queue satisfies this condition (such as reaching a certain stability, quantity, or time threshold), the solution of the present disclosure determines the third noise level (which is smoother and more reliable) based on these second noise levels. This process may be regarded as second-stage “buffering”, which further smooths the fluctuations of noise levels and enhances the accuracy of noise estimation.

Subsequently, the solution of the present disclosure adjusts the playback volume of the device based on the dual-buffered and smoothed third noise level. Since the third noise level is relatively stable and accurate, this solution for volume adjustment may avoid sudden volume changes, delivering a more consistent and seamless auditory experience for users.

Various example implementations of the solution will be described in detail below with reference to the accompanying drawings.

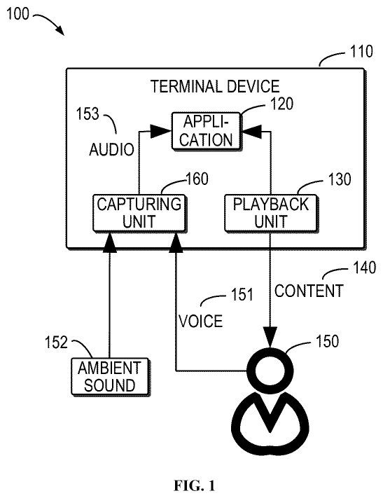

FIG. 1 illustrates a schematic diagram of an example environment 100 in which embodiments of the present disclosure can be implemented. Referring to FIG. 1, the example environment 100 may include a terminal device 110.

In the example environment 100, the terminal device 110 may be provided with an application 120 for implementing an audio playing function. The application 120 may process various types of content including audio to be played, including but not limited to, various videos, songs, or telephone voices. As an example, the application 120 may process the content including the audio to be played, and output the processed content 140 as sound to the user 150 through the playback unit 130 of the terminal device 110. The playback unit 130 may be, for example, a speaker or the like.

In addition to the audio playback function, the terminal device 110 may further be equipped with a capturing unit 160 configured to implement the sound capture function. The capturing unit 160 may capture the human voice 151 of the user 150 and the ambient sound 152 around the terminal device 110. As an example, the capturing unit 160 may include, but is not limited to, a microphone or a microphone array. The capturing unit 160 may process the captured human voice 151 and the ambient sound 152 into audio 153, and send the audio 153 to the application 120. The application 120 may automatically adjust the playback volume of the terminal device 110 according to the noise level of the audio 153, enabling the user 150 to clearly hear the content 140 in different environments.

In some embodiments, the terminal device 110 may be a wearable device, including an earphone, a wearable speaker, glasses with built-in audio playback function, a smart band, a watch, or the like. The terminal device 110 may output the content 140 to the user 150 through a built-in speaker.

In other embodiments, the terminal device 110 may also be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices, or any combination thereof. In some embodiments, the terminal device 110 may also support any type of interface for a user (such as a “wearable” circuit, etc.). Such a terminal device 110 may output the content 140 to the user 150 through a built-in speaker, an external speaker, or an external earphone.

It should be understood that the structures and functions of the various elements in the environment 100 are described for illustrative purposes only and do not imply any limitation to the scope of the present disclosure.

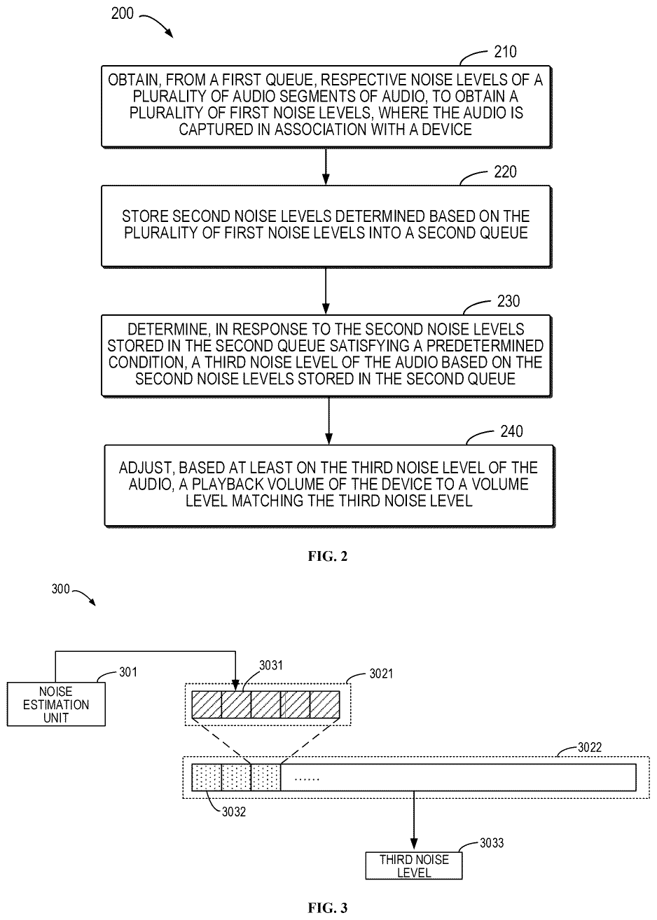

FIG. 2 illustrates a flowchart of an example process 200 for volume adjustment according to some embodiments of the present disclosure. The process 200 will be described below with reference to FIG. 1, where the process 200 may be implemented at the terminal device 110.

At block 210, the terminal device 110 obtains, from a first queue, respective noise levels of a plurality of audio segments of audio, to obtain a plurality of first noise levels. The audio 153 may be captured in association with the terminal device 110, and the audio 153 may be used for performing noise estimation.

Depending on the specific environment where the terminal device 110 is located, the audio 153 may include the ambient sound 152 and the human voice 151. The ambient sound 152 may include, but is not limited to, wind noise, vehicle sound, and other similar noise. The audio segment may refer to a short-time piece of audio data in the audio 153, and the audio segment may be of any length.

FIG. 3 illustrates a schematic diagram of an example 300 of a first queue and a second queue according to some embodiments of the present disclosure.

Referring to FIG. 3, in some embodiments, the terminal device 110 may further be provided with a noise estimation unit 301, and each audio segment may include one or more audio frames. The noise estimation unit 310 may determine a noise level of an audio segment based on the audio frames in the audio segment. As an example, the noise level may be a numerical value reflecting the noise intensity in the audio segment. It may be determined through noise estimation based on energy of the audio segment, spectrum information (where the spectrum information may be determined based on Fast Fourier Transform, with the number of frequency bins being less than or equal to 256, etc.), energy spectrum information, signal-to-noise ratio, or other related features. As an example, the terminal device 110 may perform noise estimation, based on the energy, spectrum, signal-to-noise ratio, or other related characteristics of the audio segment, through method such as loudness calculation or root mean square (RMS) calculation. It should be noted that the description regarding noise estimation is merely illustrative. Depending on actual needs, noise estimation may also be implemented in other forms. For example, the number of the frequency bins is not limited to 256, and may be other values, etc.

In some embodiments, the noise level of an audio segment may be determined based on respective noise estimations of a plurality of audio frames in the audio segment. For example, the noise level of an audio segment may be determined based on an average of respective noise estimations of all or some of the audio frames in the audio segment. In this way, on the one hand, the terminal device 110 may achieve noise estimation at a single-frame level (which helps reduce the complexity of noise estimation, thereby saving memory and computing power). On the other hand, the terminal device 110 may also smooth the jitter caused by noise estimation based on the single audio frame. Further, as previously described, embodiments of the present disclosure may achieve dual buffering of noise levels based on the first queue and the second queue, thereby further smoothing the jitter caused by noise estimation based on the single audio frame. Thus, embodiments of the present disclosure may make the single-frame-based noise estimation a widely applicable solution.

In some embodiments, once the noise estimation unit 301 determines the noise level of a certain audio segment, the terminal device 110 may store the noise level determined by the noise estimation unit 301 into the first queue 3021. The noise level stored in the first queue 3021 may also be referred to as the first noise level 3031. Then, in response to the noise level stored in the first queue 3021 reaching a storage limit of the first queue 3021, or a waiting duration of the first queue 3021 reaches a predetermined waiting duration corresponding to the first queue 3021, the terminal device 110 may obtain the plurality of first noise levels 3031 from the first queue 3021.

Referring back to FIG. 2, at block 220, the terminal device 110 stores second noise levels 3032 determined based on the plurality of first noise levels 3031 into the second queue 3022.

In some embodiments, the terminal device 110 may determine the second noise levels 3032 by, for example, calculating an average, a median, a weighted average, or the like (e.g., assigning different weights according to importance or credibility of the noise levels) of the first noise levels 3031. In some embodiments of the present disclosure, the terminal device 110 may determine the second noise levels 3032 by calculating an average value of the first noise levels 3031. In this way, the jitter in the first noise levels 3031 may be smoothed more effectively.

In some embodiments, the length of the second queue 3022 may be greater than the length of the first queue 3021. As described above, embodiments of the present disclosure may achieve dual buffering through the first queue 3021 and the second queue 3022. Thus, the second queue 3022 may also be referred to as a large buffer, and the first queue 3021 may also be referred to as a small buffer.

At block 230, in response to the second noise level 3032 stored in the second queue 3022 satisfying a predetermined condition, the terminal device 110 determines a third noise level 3033 of the audio 153 based on the second noise level 3032 stored in the second queue 3022.

The predetermined condition may be configured to indicate the timing for the terminal device 110 to extract the second noise level 3032 from the second queue 3022. In some embodiments, the predetermined condition may indicate that a waiting duration of the second queue 3022 exceeds the waiting duration corresponding to the second queue 3022. In some other embodiments, the predetermined condition may at least indicate that the second noise level 3032 currently stored in the second queue 3022 reaches a storage limit of the second queue 3022. By reasonably setting the storage limit of the second queue 3022, the jitter of the noise level may be effectively smoothed, and the terminal device 110 may process the second noise level 3032 in the second queue 3022 timely. Thus, real-time adjustment of the playback volume of the terminal device 110 may be achieved, and the volume adjustment latency may be reduced.

Once the predetermined condition is satisfied, the terminal device 110 may perform a series of calculations on the second noise levels 3032 stored in the second queue 3022 to determine the third noise level 3033. As an example, the terminal devices 110 may determine the third noise level 3033 by calculating a median, an average, a weighted average, etc. of the second noise levels 3032.

In some embodiments, the terminal device 110 may sort the second noise levels 3032 stored in the second queue 3022 based on values of the second noise levels 3032 to obtain a noise level sequence. The terminal device 110 may then determine the third noise level 3033 of the audio based on the second noise level 3032 at a predetermined position in the noise level sequence.

As an example, the sorting may be determined according to actual needs. For example, the terminal device 110 may arrange the second noise levels 3032 in ascending order or descending order of noise levels. After obtaining the noise level sequence, the terminal device 110 may determine the third noise level 3033 of the audio 153 based on the second noise level 3032 at the predetermined position in the sequence. The predetermined position may be determined according to actual needs. For example, the predetermined position may be the median position, average position, or other statistically significant position in the noise level sequence. It should be noted that, if the length of the noise level sequence is odd, the median position may be the positive middle of the noise level sequence. If the length of the noise level sequence is even, the median position may be a position between two middle second noise levels 3032 in the noise level sequence.

By selecting the second noise level 3032 at the predetermined position, the terminal device 110 may determine the third noise level 3033 that is more representative and better reflects the overall noise characteristics of the second noise level 3032 in the second queue 3022.

In some embodiments, the predetermined position may correspond to the remaining second noise level 3032 in the noise level sequence after excluding first X % and last Y % of second noise levels 3032. X and Y may be any real numbers, and may be adjusted in real time as needed. The terminal device 110 may determine the third noise level 3033 based on the median of the remaining second noise levels 3032 in the noise level sequence after excluding the first X % and last Y % of second noise levels 3032. In this way, the third noise level 3033 may reduce the impact of transient noise in the second noise level 3032.

At block 240, the terminal device 110 adjusts, based at least on the third noise level 3033 of the audio 153, a playback volume of the terminal device 110 to a volume level matching the third noise level 3033.

The volume level of the playback volume of the terminal device 110 may refer to the loudness or intensity of the sound emitted by the terminal device 110 when it plays the content 140. The higher the volume level, the louder the sound emitted by the terminal device 110. The lower the volume level, the quieter the sound emitted by the terminal device 110. The volume level may be represented by numbers, percentages, or decibels (dB).

As an example, the terminal device 110 may determine the target volume level of its playback volume based on the third noise level 3033 and possibly other factors (for example, the actual volume of the content played the terminal device 110, the preference set by the user 150, the type of the content 140, etc.). This target volume level should be high enough to ensure that the content 140 may still be heard by the user 150 in the noisy environment. Meanwhile, the target volume level should not be excessively high to avoid causing discomfort or hearing damage to the user 150. The terminal device 110 may adjust its playback volume to this target volume level. The adjustment process may be automatic, or performed after confirmation by the user 150, which is not limited in the embodiments of the present disclosure.

In some embodiments, the terminal device 110 may determine an adjustment gain for adjusting the playback volume based on the third noise level 3033, and adjust its playback volume to the volume level matching the third noise level 3033 based on the determined adjustment gain. It should be noted that the gain may refer to a degree of amplification of the volume level of an audio signal by a system or a device. The gain may be typically measured in dB, indicating how much the volume level of the audio signal increases compared to the initial volume level after passing through the system or device. In the present disclosure, the adjustment gain, or similar expression may refer to the change in the gain of the terminal device 110. For example, the adjustment gain may be superimposed on the current gain of the terminal device 110, such that the terminal device 110 increases or decreases its playback volume to reach the corresponding volume level.

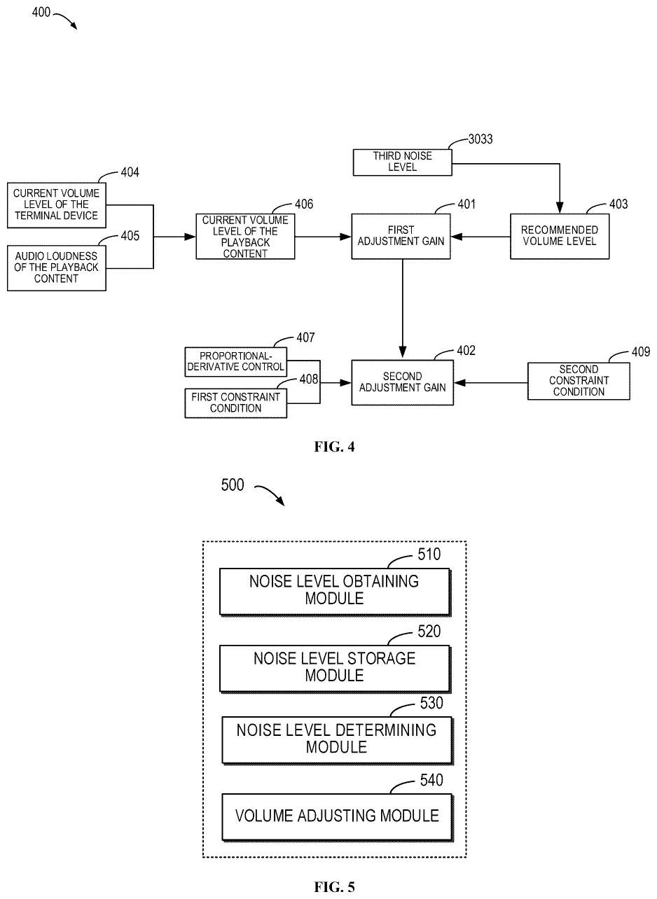

FIG. 4 illustrates a schematic diagram of an example process 400 of determining an adjustment gain according to some embodiments of the present disclosure.

Referring to FIG. 4, in some embodiments, the terminal device 110 may determine a first adjustment gain 401 for the playback volume of the terminal device 110 based at least on the third noise level 3033. Then, the terminal device 110 may determine, based at least on a first weight for the first adjustment gain and a second weight for a reference adjustment gain, a second adjustment gain by performing a weighted summation on the first adjustment gain and the reference adjustment gain. Then, the terminal device 110 may adjust its playback volume based on the second adjustment gain 402.

As an example, the first adjustment gain 401 may refer to an amount by which the terminal device 110 needs to adjust its gain under the third noise level 3033 to ensure that the user 150 can clearly hear the content 140. The adjustment gain may reflect a deviation between the actual gain of the terminal device 110 and the theoretical gain, and thus may also be referred to as a gain error.

As an example, the reference adjustment gain may be a preset fixed value, or dynamically determined based on factors such as historical gain adjustment data of the terminal device 110, user habits, etc. The specific values of the first weight and the second weight may be set according to actual conditions, to reflect the relative importance of different factors on volume adjustment.

Once the second adjustment gain 402 is determined, the terminal device 110 may adjust its playback volume based on the second adjustment gain 402. For example, the terminal device 110 may superimpose the second adjustment gain 402 on its current gain, thereby increasing (if the second adjustment gain 402 is positive) or decreasing (if the second adjustment gain 402 is negative) the playback volume to reach the corresponding volume level.

It may be seen that the terminal device 110 determines the initial adjustment gain (i.e., the first adjustment gain 401) based at least on the third noise level 3033, and further refines it by introducing the reference adjustment gain and the weight mechanism, finally obtaining the second adjustment gain 402 for adjusting its playback volume. In this way, the current noisy environment and user requirements may be more accurately adapted, such that better auditory experience may be provided.

In some embodiments, the terminal device 110 may determine a recommended volume level 403 for its playback content (e.g., the content 140) based on the third noise level 3033 and then determine a current volume level 406 of the content 140 based on at least one of its current volume level 404 and an audio loudness 405 corresponding to the content 140. Then, the terminal device 110 may determine the first adjustment gain 401 based on a difference between the current volume level 406 of the content 140 and the recommended volume level 403.

As an example, the terminal device 110 may determine, based on the third noise level 3033, the recommended volume level for the currently played video through predefined rules or algorithms. The recommended volume level should ensure that the user 150 may clearly hear the content 140 under the third noise level 3033. As an example, if the third noise level 3033 is relatively high (e.g., the terminal device 110 is in the noisy environment), the terminal device 110 may determine a higher volume level as the recommended volume level 403. As an example, if the third noise level 3033 is relatively low (e.g., the terminal device 110 is in a quiet environment), the terminal device 110 may determine a lower volume level as the recommended volume level 403.

As an example, the current volume level 404 of the terminal device 110 may refer to the volume level currently set by the terminal device 110, which may be set by the user 150 or adjusted by the terminal device 110 based on the previously determined noise level. The audio loudness 405 of the content 140 may refer to the inherent volume characteristic of the content 140. By integrating its current volume level 404 and the audio loudness 405 of the content 140, the terminal device 110 may accurately evaluate the actual volume level of the content 140, thereby reducing differences in volume adjustment caused by the differences in audio loudness across different content. Then, the terminal device 110 may determine the actual volume level as the current volume level 406 of the content 140.

Once the current volume level 406 of the content 140 and the recommended volume level 403 are determined, the terminal device 110 may determine the first adjustment gain 401 based on the difference between the current volume level 406 of the content 140 and the recommended volume level 403. The first adjustment gain 401 may be used to reduce the difference between the current volume level 406 and the recommended volume level 403. For example, if the current volume level 406 is lower than the recommended volume level 403, the terminal device 110 may determine a positive first adjustment gain 401 to increase the playback volume of the terminal device 110. On the contrary, if the current volume level 406 is higher than the recommended volume level 403, the terminal device 110 may determine a negative first adjustment gain 401 to reduce the playback volume of the terminal device 110.

In some embodiments, the determination process of the second adjustment gain 402 may be implemented based on proportional-derivative control. Proportional-derivative control (also known as PD control) is a simplified form of proportional-integral-derivative control (also known as PID control), which combines the advantages of proportional control and derivative control. Proportional control (also referred to as P control) adjusts the output according to the magnitude of the current error, and the derivative control (also referred to as D control) adjusts the output according to the change rate of the error to predict and compensate the error in advance. To meet the requirement of PD control, embodiments of the present disclosure may determine the reference adjustment gain in the following manner, enabling it to serve as one of the factors in the derivative control. The terminal device 110 may determine the reference adjustment gain based on the difference between the first adjustment gain 401 and the third adjustment gain. The third adjustment gain is determined based on a fourth noise level, the third noise level is determined for the audio at a first time point, and the fourth noise level is determined for the audio at a second time point prior to the first time point.

As an example, the terminal device 110 may periodically detect the noise level of the surrounding environment. For the noise level detection process, reference may be made to the description about the third noise level 3033 in the foregoing embodiment, and details are not described herein again. In addition, each time the terminal device 110 detects the noise level, it may adjust the volume level of the playback volume according to the detected noise level. For this process, reference may be made to the description about adjusting the playback volume level in the foregoing embodiment, and details are not described herein again.

Based on this, the terminal device 110 may determine the reference adjustment gain based on the initial adjustment gain (i.e., the first adjustment gain 401) determined in the current playback volume adjustment process and the adjustment gain (i.e., the third adjustment gain) determined in the previous playback volume adjustment process.

In some embodiments of the present disclosure, the terminal device 110 may determine the reference adjustment gain based on the difference between the first adjustment gain 401 and the third adjustment gain. As previously described, the adjustment gain may also be referred to as the gain error. Thus, the difference between the first adjustment gain 401 and the third adjustment gain may actually represent the change in gain error caused by noise level variations from the second time point to the first time point.

After obtaining the reference adjustment gain, the determination process of the second adjustment gain 402 may be implemented based on the proportional-derivative control 407. The proportional-derivative control 407 may be represented by formula (1) and formula (2):

$$Δ G = {K}_{p} \cdot e ( t ) + {K}_{d} \cdot {e ( t )}^{′} \qquad ( 1 )$$

$${e ( t )}^{′} = e ( t ) - e ( t - 1 ) \qquad ( 2 )$$

where ΔG denotes the second adjustment gain 402, e (t) denotes the first adjustment gain 401, Kₚ denotes the first weight, K_{d} denotes the second weight, e(t)′ denotes the reference adjustment gain, e(t−1) denotes the third adjustment gain, t denotes the first time point, and t−1 denotes the second time point before the first time point. In the proportional-derivative control 407, Kₚ is also be referred to as a proportional coefficient, and K_{d} is also be referred to as a derivative coefficient.

Through the proportional-derivative control, the terminal device 110 may achieve smooth transitions between consecutively determined adjustment gains, thereby minimizing the intrusiveness of volume adjustments and enabling seamless audio level adjustment.

In some embodiments, the terminal device 110 may determine, based on the first weight, the second weight, and a first constraint condition 408, the second adjustment gain 402 by performing weighted summation on the first adjustment gain 401 and the reference adjustment gain. The first constraint condition 408 may at least indicate that the second adjustment gain 402 is less than or equal to a predetermined adjustment gain upper limit. As an example, the first constraint condition 408 may be represented by the formula (3):

$$Δ G = min ( Δ {G}_{C} , {G}_{max} ) \qquad ( 3 )$$

where ΔG_{C} denotes the weighted summation result of the first adjustment gain 401 and the reference adjustment gain, and Gₘₐₓ denotes the predetermined adjustment gain upper limit.

In addition, the first constraint condition may further include other content according to actual needs, which is not enumerated herein.

In some embodiments, the terminal device 110 may adjust its playback volume to the volume level matching the third noise level 3033 based on the third noise level 3033 of the audio 153 and a second constraint condition 409. The second constraint condition 409 may at least indicate that the volume level of the adjusted playback volume is lower than a volume upper limit for the terminal device 110.

As an example, the volume upper limit may be set based on hardware specifications of the terminal device 110 (e.g., maximum power of the speaker, maximum gain of the amplifier, etc.) and/or user preferences. Different terminal devices 110 may have different volume upper limits, and this manner may be referred to as adaptive volume limiting. In the process of adjusting the playback volume of the terminal device 110, the terminal device 110 may monitor the volume level of the playback volume, so as to determine, based on the second constraint condition 409, that the adjusted volume level is always lower than the volume upper limit, thereby avoiding problems such as hearing damage caused by excessively loud volume.

In some embodiments, in response to detecting a volume adjustment indication for the terminal device 110, the terminal device 110 may adjust its playback volume based on the third noise level 3033 and the adjustment gain corresponding to the volume adjustment indication.

As an example, the volume adjustment indication for the terminal device 110 may be triggered through various appropriate means. For example, the user 150 may initiate the volume adjustment indication through a volume adjustment button of the terminal device 110, a touchscreen of the terminal device 110, or other input manners. In this case, the terminal device 110 may determine how to adjust the playback volume of the terminal device 110 based on the third noise level 3033 and the adjustment gain corresponding to the volume adjustment indication. In this way, when the user 150 is not satisfied with the volume level adjusted by the terminal device 110 based on the third noise level 3033, he/she may further adjust the playback volume of the terminal device 110 through manual operation.

In some embodiments, the volume level of the playback volume of the terminal device 110 may be quantitatively represented in the form of a volume step or the like. As an example, under the same volume adjustment indication, the terminal device 110 may determine different adjustment gains based on different values of the quantized representation. This manner may also be referred to as adaptive gain offset. Through the adaptive gain offset, regardless of the degree to which the terminal device 110 adjusts the playback volume, after the user 150 initiates the volume adjustment indication, the terminal device 110 may still make the user 150 perceive a distinct “sense of adjustment” in volume, and this sense of adjustment in volume may be natural with stronger controllability. As an example, the terminal device 110 may adopt different adjustment gains for different volume steps in the terminal device 110. For example, when the volume step of the terminal device 110 is small (for example, the third noise level 3033 is low, and the terminal device 110 adjusts the playback volume to a lower volume level), after detecting the volume adjustment indication from the user 150, the terminal device 110 may adjust the volume by using a relatively small adjustment gain. When the volume step is large (for example, the third noise level 3033 is high, and the terminal device 110 adjusts the playback volume to a higher volume level), after detecting the volume adjustment indication from the user 150, the terminal device 110 may adjust the volume by using a larger adjustment gain, such that the user may still perceive the “sense of adjustment” in volume when performing manual volume adjustments.

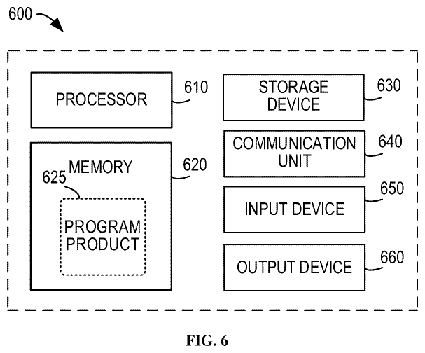

Embodiments of the present disclosure also provide a corresponding apparatus for implementing the above method or process. FIG. 5 illustrates a schematic block diagram of an apparatus 500 for volume adjustment according to some embodiments of the present disclosure. The apparatus 500 may be implemented or included in the terminal device 110. The various modules/components in the apparatus 500 may be implemented by hardware, software, firmware, or any combination thereof.

Referring to FIG. 5, the apparatus 500 includes a noise level obtaining module 510, a noise level storage module 520, a noise level determining module 530, and a volume adjusting module 540. The noise level obtaining module 510 is configured to obtain, from the first queue 3021, respective noise levels of a plurality of audio segments of audio to obtain a plurality of first noise levels 3031. The audio is captured in association with a device. The noise level storage module 520 is configured to store the second noise level 3032 determined based on the plurality of first noise levels 3031 into the second queue 3022. The noise level determining module 530 is configured to determine, in response to the second noise levels 3032 stored in the second queue 3022 satisfying the predetermined condition, a third noise level 3033 of the audio based on the second noise levels 3032 stored in the second queue 3022. The volume adjusting module 540 is configured to adjust the playback volume of the device to a volume level matching the third noise level 3033 based at least on the third noise level 3033 of the audio.

In some embodiments, the noise level determining module 530 is further configured to sort the second noise levels stored in the second queue based on values of the second noise levels stored in the second queue, to obtain a noise level sequence; and determine the third noise level of the audio based on a second noise level at a predetermined position in the noise level sequence.

In some embodiments, the predetermined condition at least indicates that the second noise levels currently stored in the second queue reaches a storage limit of the second queue.

In some embodiments, the volume adjusting module 540 is further configured to adjust, in response to detecting a volume adjustment indication for the device, the playback volume of the device based on the third noise level and an adjustment gain corresponding to the volume adjustment indication.

In some embodiments, the volume adjusting module 540 is configured to determine a first adjustment gain for the playback volume of the device based at least on the third noise level; determine, based at least on a first weight for the first adjustment gain and a second weight for a reference adjustment gain, a second adjustment gain by performing a weighted summation on the first adjustment gain and the reference adjustment gain; and adjust the playback volume of the device based on the second adjustment gain.

In some embodiments, the volume adjusting module 540 is further configured to determine a recommended volume level for playback content of the device based on the third noise level; determine a current volume level of the playback content based on at least one of: a current volume level of the device or an audio loudness corresponding to the playback content of the device; and determine the first adjustment gain based on a difference between the current volume level of the playback content and the recommended volume level.

In some embodiments, the reference adjustment gain is determined by determining the reference adjustment gain based on a difference between the first adjustment gain and a third adjustment gain, where the third adjustment gain is determined based on a fourth noise level, the third noise level is determined for the audio at a first time point, and the fourth noise level is determined for the audio at a second time point prior to the first time point.

In some embodiments, the volume adjusting module 540 is further configured to: determine, based on the first weight, the second weight, and a first constraint condition, the second adjustment gain by performing the weighted summation on the first adjustment gain and the reference adjustment gain, wherein the first constraint condition at least indicates that the second adjustment gain is less than or equal to a predetermined adjustment gain upper limit.

In some embodiments, the volume adjusting module 540 is further configured to adjust, based on the third noise level of the audio and a second constraint condition, the playback volume of the device to the volume level matching the third noise level, wherein the second constraint condition at least indicates that the adjusted volume level of the playback volume is lower than a volume upper limit for the device.

In some embodiments, a noise level of each audio segment of the plurality of audio segments is determined based on respective noise estimates of a plurality of audio frames in the audio segment.

FIG. 6 illustrates a block diagram of an electronic device 600 in which one or more embodiments of the present disclosure may be implemented. For example, the electronic device 600 may be configured to implement the terminal device 110 illustrated in FIG. 1 or the apparatus 500 illustrated in FIG. 5. It should be understood that the electronic device 600 illustrated in FIG. 6 is merely illustrative and should not constitute any limitation on the functionality and scope of the embodiments described herein.

Referring to FIG. 6, the electronic device 600 is in the form of a general-purpose electronic device. Components of the electronic device 600 may include, but are not limited to, one or more processors 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not illustrated in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not illustrated) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not illustrated) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not illustrated).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. Determination of the terms used herein is intended to best explain the principles of the implementations, practical applications, or improvements to the technology in the marketplace, or to enable others of ordinary skill in the art to understand the various implementations disclosed herein.

What is claimed is:

1. A method for volume adjustment, comprising:
obtaining, from a first queue, respective noise levels of a plurality of audio segments of audio, to obtain a plurality of first noise levels, wherein the audio is captured in association with a device;
storing second noise levels determined based on the plurality of first noise levels into a second queue;
determining, in response to the second noise levels stored in the second queue satisfying a predetermined condition, a third noise level of the audio based on the second noise levels stored in the second queue; and
adjusting, based at least on the third noise level of the audio, a playback volume of the device to a volume level matching the third noise level.

2. The method of claim 1, wherein determining the third noise level of the audio based on the second noise levels stored in the second queue comprises:
sorting the second noise levels stored in the second queue based on values of the second noise levels stored in the second queue, to obtain a noise level sequence; and
determining the third noise level of the audio based on a second noise level at a predetermined position in the noise level sequence.

3. The method of claim 1, wherein the predetermined condition at least indicates that the second noise levels currently stored in the second queue reaches a storage limit of the second queue.

4. The method of claim 1, wherein adjusting the playback volume of the device to the volume level matching the third noise level comprises:
adjusting, in response to detecting a volume adjustment indication for the device, the playback volume of the device based on the third noise level and an adjustment gain corresponding to the volume adjustment indication.

5. The method of claim 1, wherein adjusting the playback volume of the device to the volume level matching the third noise level comprises:
determining a first adjustment gain for the playback volume of the device based at least on the third noise level;
determining, based at least on a first weight for the first adjustment gain and a second weight for a reference adjustment gain, a second adjustment gain by performing a weighted summation on the first adjustment gain and the reference adjustment gain; and
adjusting the playback volume of the device based on the second adjustment gain.

6. The method of claim 5, wherein determining the first adjustment gain for the playback volume of the device based at least on the third noise level comprises:
determining a recommended volume level for playback content of the device based on the third noise level;
determining a current volume level of the playback content based on at least one of: a current volume level of the device or an audio loudness corresponding to the playback content of the device; and
determining the first adjustment gain based on a difference between the current volume level of the playback content and the recommended volume level.

7. The method of claim 5, wherein the reference adjustment gain is determined by:
determining the reference adjustment gain based on a difference between the first adjustment gain and a third adjustment gain, wherein the third adjustment gain is determined based on a fourth noise level, the third noise level is determined for the audio at a first time point, and the fourth noise level is determined for the audio at a second time point prior to the first time point.

8. The method of claim 5, wherein determining the second adjustment gain by performing the weighted summation on the first adjustment gain and the reference adjustment gain based at least on the first weight for the first adjustment gain and the second weight for the reference adjustment gain comprises:
determining, based on the first weight, the second weight, and a first constraint condition, the second adjustment gain by performing the weighted summation on the first adjustment gain and the reference adjustment gain, wherein the first constraint condition at least indicates that the second adjustment gain is less than or equal to a predetermined adjustment gain upper limit.

9. The method of claim 1, wherein adjusting the playback volume of the device to the volume level matching the third noise level comprises:
adjusting, based on the third noise level of the audio and a second constraint condition, the playback volume of the device to the volume level matching the third noise level, wherein the second constraint condition at least indicates that the adjusted volume level of the playback volume is lower than a volume upper limit for the device.

10. The method of claim 1, wherein a noise level of each audio segment of the plurality of audio segments is determined based on respective noise estimates of a plurality of audio frames in the audio segment.

11. An electronic device, comprising:
at least one processor; and
at least one memory coupled to the at least one processor and storing instructions executable by the at least one processor, the instructions, when executed by the at least one processor, causing the electronic device to perform operations comprising:
obtaining, from a first queue, respective noise levels of a plurality of audio segments of audio, to obtain a plurality of first noise levels, wherein the audio is captured in association with a device;
storing second noise levels determined based on the plurality of first noise levels into a second queue;
determining, in response to the second noise levels stored in the second queue satisfying a predetermined condition, a third noise level of the audio based on the second noise levels stored in the second queue; and
adjusting, based at least on the third noise level of the audio, a playback volume of the device to a volume level matching the third noise level.

12. The electronic device of claim 11, wherein determining the third noise level of the audio based on the second noise levels stored in the second queue comprises:
sorting the second noise levels stored in the second queue based on values of the second noise levels stored in the second queue, to obtain a noise level sequence; and
determining the third noise level of the audio based on a second noise level at a predetermined position in the noise level sequence.

13. The electronic device of claim 11, wherein the predetermined condition at least indicates that the second noise levels currently stored in the second queue reaches a storage limit of the second queue.

14. The electronic device of claim 11, wherein adjusting the playback volume of the device to the volume level matching the third noise level comprises:
adjusting, in response to detecting a volume adjustment indication for the device, the playback volume of the device based on the third noise level and an adjustment gain corresponding to the volume adjustment indication.

15. The electronic device of claim 11, wherein adjusting the playback volume of the device to the volume level matching the third noise level comprises:
determining a first adjustment gain for the playback volume of the device based at least on the third noise level;
determining, based at least on a first weight for the first adjustment gain and a second weight for a reference adjustment gain, a second adjustment gain by performing a weighted summation on the first adjustment gain and the reference adjustment gain; and
adjusting the playback volume of the device based on the second adjustment gain.

16. The electronic device of claim 15, wherein determining the first adjustment gain for the playback volume of the device based at least on the third noise level comprises:
determining a recommended volume level for playback content of the device based on the third noise level;
determining a current volume level of the playback content based on at least one of: a current volume level of the device or an audio loudness corresponding to the playback content of the device; and
determining the first adjustment gain based on a difference between the current volume level of the playback content and the recommended volume level.

17. The electronic device of claim 15, wherein the reference adjustment gain is determined by:
determining the reference adjustment gain based on a difference between the first adjustment gain and a third adjustment gain, wherein the third adjustment gain is determined based on a fourth noise level, the third noise level is determined for the audio at a first time point, and the fourth noise level is determined for the audio at a second time point prior to the first time point.

18. The electronic device of claim 15, wherein determining the second adjustment gain by performing the weighted summation on the first adjustment gain and the reference adjustment gain based at least on the first weight for the first adjustment gain and the second weight for the reference adjustment gain comprises:
determining, based on the first weight, the second weight, and a first constraint condition, the second adjustment gain by performing the weighted summation on the first adjustment gain and the reference adjustment gain, wherein the first constraint condition at least indicates that the second adjustment gain is less than or equal to a predetermined adjustment gain upper limit.

19. The electronic device of claim 11, wherein adjusting the playback volume of the device to the volume level matching the third noise level comprises:
adjusting, based on the third noise level of the audio and a second constraint condition, the playback volume of the device to the volume level matching the third noise level, wherein the second constraint condition at least indicates that the adjusted volume level of the playback volume is lower than a volume upper limit for the device.

20. A non-transitory computer-readable storage medium having stored thereon computer-executable instructions executable by a processor to perform operations comprising:
obtaining, from a first queue, respective noise levels of a plurality of audio segments of audio, to obtain a plurality of first noise levels, wherein the audio is captured in association with a device;
storing second noise levels determined based on the plurality of first noise levels into a second queue;
determining, in response to the second noise levels stored in the second queue satisfying a predetermined condition, a third noise level of the audio based on the second noise levels stored in the second queue; and
adjusting, based at least on the third noise level of the audio, a playback volume of the device to a volume level matching the third noise level.
